(19) United States
(12) Patent Application Publication
(10) Pub. No.: US 2010/0171979 A1
(43) Pub. Date: Jul. 8, 2010

(54) WIRELESS PRINTING SYSTEM AND METHOD

(75) Inventor: Ye Yuan, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/537,650

(22) Filed: Aug. 7, 2009

(30) Foreign Application Priority Data
Jan. 5, 2009 (CN) 200910300032.2

(51) Int. Cl. G06F 3/12

(52) U.S. Cl. 358/1.15

(57) ABSTRACT

A printing method includes following steps. A first port of a digital photo frame sends a broadcast signal to search for a printer. The digital photo frame connects to the printer via a wireless connection. The printer responds to the broadcast signal. A second port of the digital photo frame submits a print request to the printer. A third port of the digital photo frame transfers a file to the printer. Then the printer prints the file out.

### BACKGROUND

1. Technical Field

The present disclosure relates to printing systems and methods, and more particularly to a wireless printing system and method for printing information stored in a digital photo frame (DPF).

2. Description of Related Art

Nowadays, DPF is a widely used electronic device. Photos and text files are viewable via a display interface of the DPF. Sometimes, the photo or text files stored in the DPF might need to be printed. A typical printing method includes following steps. The photo or text file is copied from the DPF and saved in a computer with a print driver installed. The computer sends a printing request and the photo or text file to a printer which is connected to the computer via a network cable. Then the printer prints the photo or text file in response to the printing request. In typical printing methods, intervening devices, such as computers or Universal Serial Bus (USB) disks, are needed to copy the information from the DPF, and then the information can be printed. The information stored in the DPF can not be directly printed by the printer.

Therefore, a wireless printing system and method capable of directly printing information stored in a DPF is desired.

### BRIEF DESCRIPTION OF THE DRAWINGS

FIG. 1 a block diagram of a wireless printing system in accordance with an embodiment of the present disclosure.

FIG. 2 is a flow chart of a wireless printing method in accordance with an embodiment of the present disclosure.

### DETAILED DESCRIPTION

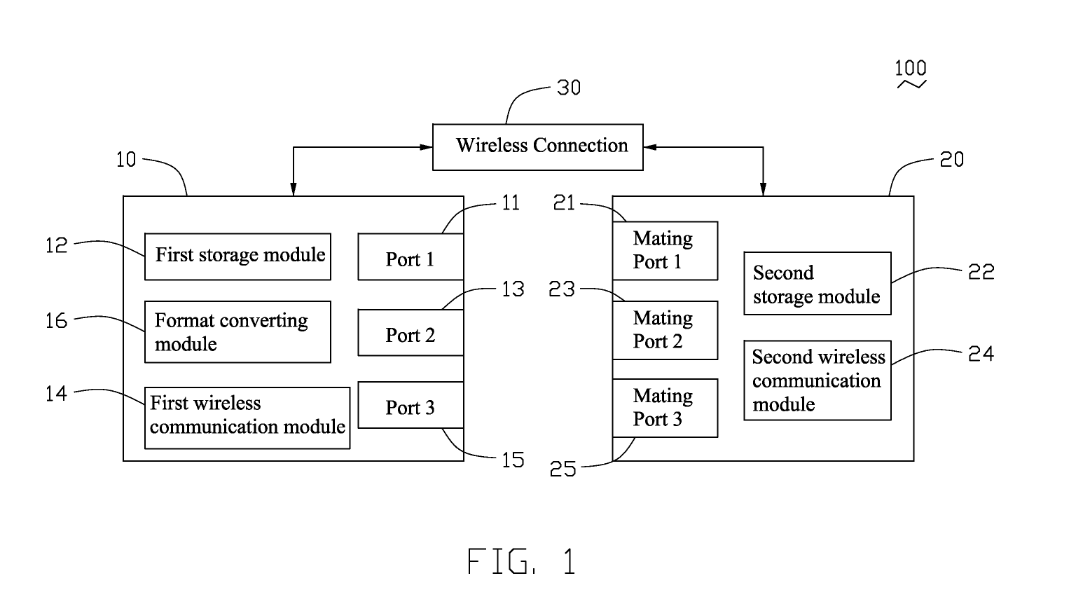

Referring to FIG. 1, an embodiment of a wireless printing system 100 includes a DPF 10 and a printer 20. The DPF 10 is communicatively connected to the printer 20 via a wireless connection 30, such as WIFI, Bluetooth, etc.

The DPF 10 includes a first storage module 12 for storing files having various formats (such as graphics formats, TXT formats), a first wireless communication module 14, and a format converting module 16. The format converting module 16 is capable of converting the text files (TXT format) into a graphics format (JPEG format), by screen capturing the file, or utilizing a draw text function (a software tool utilized for converting files between formats) to convert the text file into the graphics format. The graphics format files of the DPF 10 are directly printable by the printer 20. The DPF 10 includes a first port 11 capable of sending a broadcast signal to search for the printer 20 (there may be a plurality of printers in the wireless network), a second port 13 capable of sending a print request to the printer 20, and a third port 15 capable of sending data of a graphical file format file to the printer 20.

The printer 20 includes a second storage module 22 for temporarily storing the files sent from the DPF 10, and a second wireless communication module 24 communicatively connectable to the first wireless communication module 14 of the DPF 10 via the wireless connection 30. The first communication module 14 and the second communication module 24 comply to/follow a same wireless communication standard, such as WIFI or Bluetooth. The printer 20 includes a first mating port 21 for receiving the broadcast signal from the first port 11 of the DPF 10, a second mating port 23 for receiving the printing request from the second port 13 of the DPF 10, and a third mating port 25 for receiving the files to be printed from the third port 15 of the DPF 10. Each of the mating ports 21, 23, 25 of the printer 20 can also send feedback signals to the DPF 10 after receiving the information from the DPF 10.

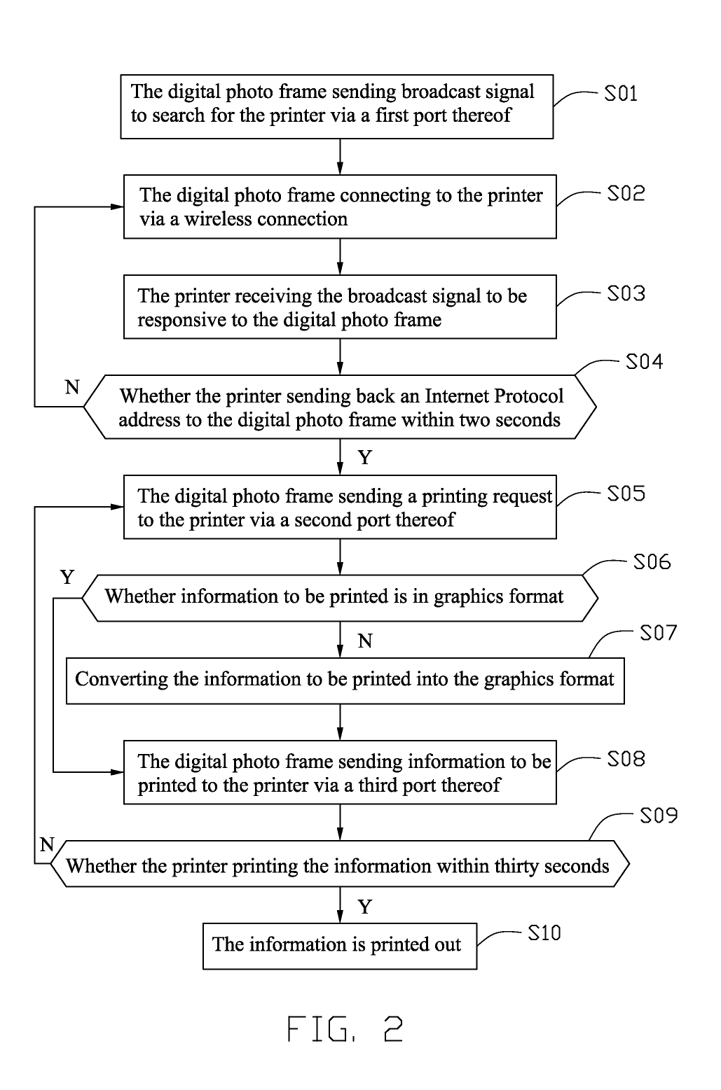

Referring to FIG. 2, an operational sequence, according to one embodiment of the system 100, includes the following blocks.

In block S01, the DPF 10 sends a broadcast signal to search for a printer via the first port 11 thereof. In block S02, the DPF 10 connects to the printer 20 via the wireless connection 30 of a wireless network. In block S03, the printer 20 receives the broadcast signal to be responsive to requests sent by the DPF 10. In block S04, if the printer 20 sends back an Internet Protocol address thereof to the DPF 10 within a time period, such as two seconds, after the DPF 10 sends the broadcast signal, go to block S05; otherwise, go to block S02. In block S05, the DPF 10 sends a printing request to the printer 20 via the second port 13 of the DPF 10. In block S06, if the file to be printed is a graphics format file, go to block S08; and if the file is a text format file, go to block S07. In block S07, the text file is converted into to the graphics format. In block S08, the DPF 10 sends the file to the printer 20 via the third port 15 thereof. In block S09, if the printer 20 prints the file within a time period, such as ten seconds, from sending the file, go to block S10; otherwise, go back to S05. In block S10, the file is printed out by the printer 20.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

It is also to be understood that the above description and the claims drawn to a method may include some indication in reference to certain steps. However, the indication used is only to be viewed for identification purposes and not as a suggestion as to an order for the steps.

What is claimed is:

1. A printing system comprising:
a printer; and
a digital photo frame connected to the printer via a wireless connection, the digital photo frame comprising a first port capable of sending broadcast signal to search for the printer, a second port capable of sending a printing request to the printer, and a third port capable of sending a file to the printer for printing;
wherein the printer is capable of responding to the printing request of the digital photo frame and printing the file out.

2. The printing system of claim 1, wherein the digital photo frame comprises a digital photo frame wireless communication module, and the printer comprises a printer communication module connected to the digital photo frame communication module via the wireless connection.

3. The printing system of claim 1, wherein the digital photo frame comprises a format converting module capable of converting the file from a first format to a second format.

4. The printing system of claim 3, wherein the first format is a text format, and the second format is a graphics format.

5. The printing system of claim 4, wherein the format converting module is capable of saving a screen of the text file as the graphics format to convert the file from the first format to the second format.

6. The printing system of claim 4, wherein the format converting module is capable of utilizing a draw text function to convert the format of the file to the graphics format.

7. The printing system of claim 1, wherein the printer comprises a first mating port for receiving the broadcast signal from the first port of the digital photo frame, a second mating port for receiving the printing request from the second port of the digital photo frame, and a third mating port for receiving the file from the third port of the digital photo frame.

8. A printing method comprising:
sending a broadcast signal to search for a printer via a first port of a digital photo frame;
connecting the digital photo frame to the printer via a wireless connection;
responding to the broadcast signal by the printer;
submitting a print request to the printer via a second port of the digital photo frame;
transferring a file to the printer via a third port of the digital photo frame; and
printing the file.

9. The printing method of claim 8, further comprising converting file from a text format to a graphics format before the transferring if the file is a text file.

10. The printing method of claim 9, wherein the converting comprising saving a screen of the text file as the graphics format.

11. The printing method of claim 8, further comprising sending back an Internet Protocol address to the digital photo frame after the printer receives the broadcast signal.

12. The printing method of claim 11, wherein if the digital photo frame does not receive the Internet Protocol address from the printer within two seconds after it sends the broadcast signal, repeating the step of sending broadcast signal.

13. The printing method of claim 12, wherein if a time interval from the transferring to the printing exceeds a preset time limit, repeating the step of sending the printing request.
